(19) United States
(12) Patent Application Publication
(10) Pub. No.: US 2026/0225536 A1
(43) Pub. Date: Aug. 6, 2026

(54) PORTABLE ELECTRONIC DEVICE ASSEMBLY AND VEHICLE EQUIPPED WITH SAME

(71) Applicant: NISSAN NORTH AMERICA, INC., Franklin, TN (US)

(72) Inventors: Nelson S. PHAN, Rochester Hills, MI (US); Arturo CRUZ HERNANDEZ, Mexico City (MX)

(21) Appl. No.: 19/042,919

(22) Filed: Jan. 31, 2025

(51) Int. Cl. B60R 11/00; B60R 16/03

(52) U.S. Cl. CPC B60R 11/00; B60R 16/03; B60R 2011/004; B60R 2011/0096

(57) ABSTRACT

A vehicle equipped with a portable electronic device assembly is disclosed herein. In an embodiment, a portable electronic device assembly for a vehicle includes a portable electronic device and a portable device holder. The portable electronic device includes a rechargeable battery. The portable device holder is configured to retain the portable electronic device while the rechargeable battery is charged by the vehicle. The portable electronic device includes a device cavity configured to receive the portable electronic device, and a locking rod configured to extend into the device cavity and be rotated when moving between (i) a locked configuration that locks the portable electronic device into the device cavity while the rechargeable battery is charged by the vehicle, and (ii) an unlocked configuration that enables the portable electronic device to be removed from the device cavity and used remotely from outside the vehicle.

### BACKGROUND

### Field of the Disclosure

The present disclosure generally relates to a portable electronic device assembly configured to be installed on a vehicle. The present disclosure also generally relates to a vehicle equipped with a portable electronic device assembly.

### Background Information

Pickup trucks are known for their usefulness in moving cargo such as lumber, furniture, and other large commercial and personal items. Cargo beds are also useful as work and recreational spaces for outdoor activities. Since many cargo beds are generally exposed at the top, portable or otherwise removable vehicle components stored therein are susceptible to theft.

### SUMMARY

The present disclosure provides a portable electronic device assembly that locks a portable electronic device within the cargo space of a vehicle. The portable electronic device is multi-functional, operable both inside and outside of the cargo space, convenient to recharge, and resistant to theft.

In view of the state of the known technology, one aspect of the present disclosure is to provide a portable electronic device assembly for a vehicle. The portable electronic device assembly includes a portable electronic device and a portable device holder. The portable electronic device includes a rechargeable battery. The portable device holder is configured to retain the portable electronic device while the rechargeable battery is charged by the vehicle. The portable device holder includes a device cavity and a locking rod. The device cavity is configured to receive the portable electronic device. The locking rod is configured to extend into the device cavity and be rotated when moving between (i) a locked configuration that locks the portable electronic device into the device cavity while the rechargeable battery is charged by the vehicle, and (ii) an unlocked configuration that enables the portable electronic device to be removed from the device cavity and used remotely from outside the vehicle.

A second aspect of the present disclosure is to provide another portable electronic device assembly for a vehicle. The portable electronic device assembly includes a portable electronic device and a portable device holder. The portable electronic device includes a rechargeable battery. The portable device holder is configured to retain the portable electronic device while the rechargeable battery is charged by the vehicle. The portable device holder includes a mount, a device cavity and a locking mechanism. The mount is configured to attach to a vehicle wall. The device cavity is configured to receive the portable electronic device. The locking mechanism is configured to be placed in a locked configuration that locks the portable electronic device into the device cavity and an unlocked configuration that enables the portable electronic device to be removed from the device cavity and used remotely from outside the vehicle.

A third aspect of the present disclosure is to provide a vehicle. The vehicle includes a vehicle battery, a passenger cabin, a cargo bed, a portable device holder and a portable electronic device. The passenger cabin includes electrical components using power from the vehicle battery. The cargo bed is located on a rear side of the passenger cabin and includes a lateral side wall. The portable device holder is attached to the lateral side wall and includes a device cavity. The portable electronic device includes a locking portion and a rechargeable battery. The portable electronic device is configured to (i) lock into the portable device holder with the locking portion located in the device cavity, (ii) have the rechargeable battery recharged by the vehicle battery when locked into the portable device holder, and (iii) unlock from the portable device holder to be used remotely from outside the cargo bed using power from the rechargeable battery.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a side elevational view of an example embodiment of a vehicle equipped with a portable electronic device assembly in accordance with the present disclosure;

FIG. 2 is a top plan view of the vehicle of FIG. 1;

FIG. 3 is a front perspective view of the cargo bed of the vehicle of FIG. 1;

FIG. 4 is a front perspective view of an example embodiment of a portable electronic device assembly in accordance with the present disclosure;

FIG. 5 is a front perspective view of an example embodiment of a portable electronic device in accordance with the present disclosure;

FIG. 6 is a front perspective view of an example embodiment of a portable device holder in accordance with the present disclosure;

FIG. 7 is a top perspective view of the portable device holder of FIG. 6;

FIG. 8 is a rear perspective view of an example embodiment of the portable device holder of FIG. 6 without the locking mechanism shown;

FIG. 9 is a front perspective view of the mounted part of the portable device holder of FIG. 6 without the locking mechanism shown;

FIG. 10 is front perspective view of an example embodiment of the locking mechanism of the portable device holder of FIG. 6;

FIG. 11 is an exploded view of the portable device holder of FIG. 6;

FIG. 12 is a cross-sectional view of the locking mechanism of FIG. 10; and

FIG. 13 is a side elevational view of the portable electronic device of FIG. 5 interacting with the locking mechanism of FIG. 10.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

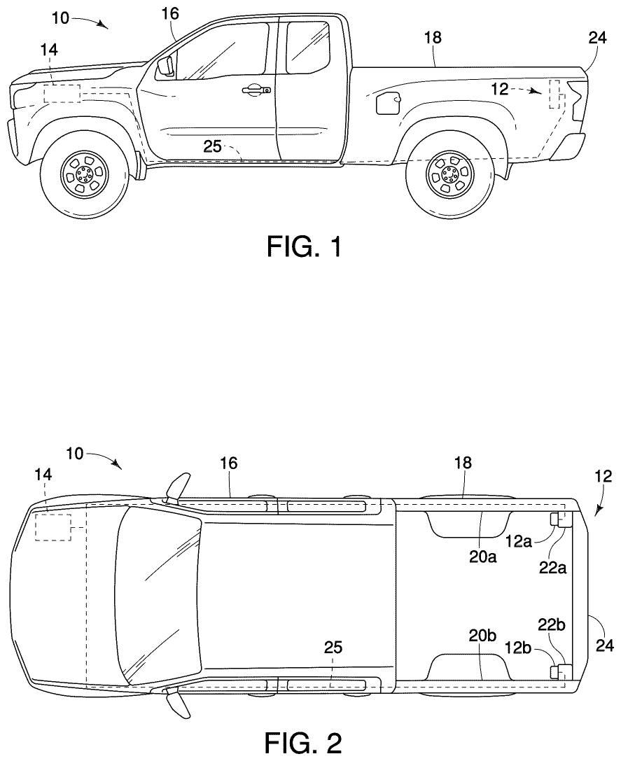

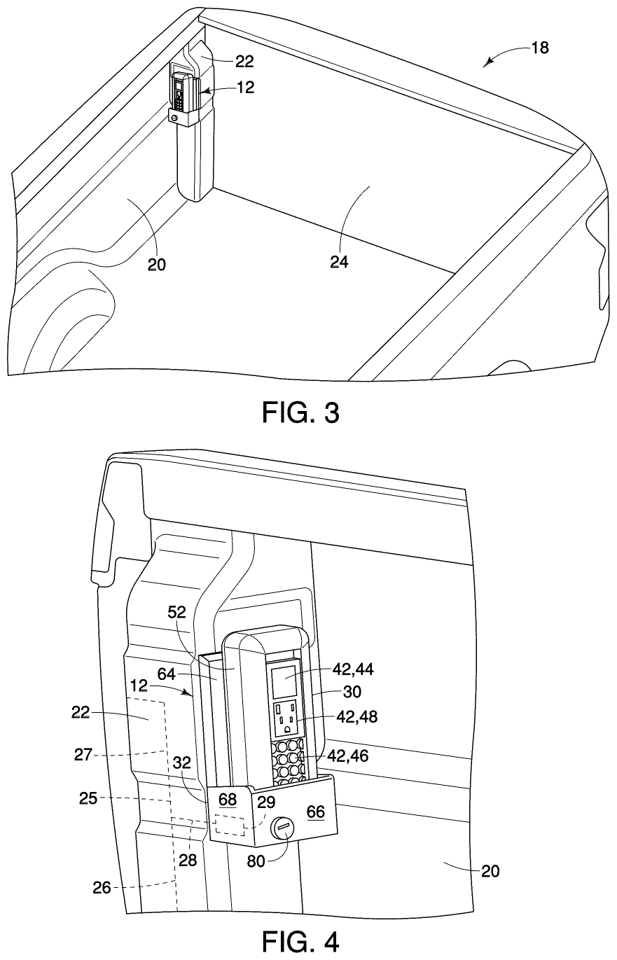

FIGS. 1 to 3 illustrates an example embodiment of a vehicle 10 equipped with a portable electronic device assembly 12 in accordance with the present disclosure. The vehicle 10 generally includes a vehicle battery 14, a passenger cabin 16 and a cargo bed 18. The passenger cabin 16 has various electrical components using power from the vehicle battery 14. The cargo bed 18 is located on the rear side of the passenger cabin 16 and has one or more lateral side walls 20 equipped with a portable electronic device assembly 12.

In the illustrated embodiment, opposite lateral side walls 20 of the vehicle 10 each include a tail light column 22 near the tailgate 24, and a portable electronic device assembly 12 is attached to each tail light column 22. That is, a first portable electronic device assembly 12a is attached to a first tail light column 22a on a first side wall 20a of the cargo bed 18, and a second portable electronic device assembly 12b is attached to a second tail light column 22b on an opposite second side wall 20b of the cargo bed 18. The first portable electronic device assembly 12a and the second portable electronic device assembly 12b are generally identical and are each referred to herein as a portable device assembly 12.

Although a pickup truck is shown and described herein, the portable electronic device assembly 12 disclosed herein can also be used in other types of vehicles 10 and in other areas besides a cargo bed 18. For example, it can be beneficial to locate a portable electronic device assembly 12 as disclosed herein inside the passenger cabin 16 of a shared truck or other vehicle 10 to prevent removal by one of the users. A portable electronic device assembly 12 installed inside the passenger cabin 16 of a truck or other vehicle 10 also protects against removal during a break-in.

As seen in FIGS. 1 to 4, the vehicle battery 14 is configured to provide power to each portable electronic device assembly 12 via electrical wiring 25 extending through or along a respective tail light column 22. In an embodiment, the portable electronic device assembly 12 can be installed on the vehicle 10 using a connection to the existing wiring 25 used to provide power from the vehicle battery 14 to the tail lights. For example, the wiring 25 can include a body harness 26 configured to electrically connect to wiring within the body of the vehicle 10, a tail light harness 27 configured to electrically connect to the tail light, and a device assembly harness 28 configured to electrically connect to an electrical contact 29 of the portable electronic device assembly 12. Using the wiring 25 shown, the portable electronic device assembly 12 can be installed on an existing vehicle 10 by disconnecting existing wiring from the tail light, connecting the body harness 26 to the existing wiring, connecting the tail light harness 27 to the tail light, and connecting the device assembly harness 28 to the portable electronic device assembly 12. The same wiring 25 can therefore power both the portable electronic device assembly 12 and the tail light using power from the vehicle battery 14.

FIG. 4 illustrates an example embodiment of the portable electronic device assembly 12. The portable electronic device assembly 12 generally includes a portable electronic device 30 and a portable device holder 32. The portable device holder 32 is configured to attach to a lateral side wall 20 of the vehicle 10. More specifically, the portable device holder 32 is configured to attach to the tail light column 22 of the lateral side wall 20 so as to be facing the rear side of the passenger cabin 16 and the length of the cargo bed 18. The portable electronic device 30 is configured to lock into the portable device holder 32 for recharging and/or use within the cargo bed 18, and to unlock from the portable device holder 32 to be used remotely from outside the cargo bed 18.

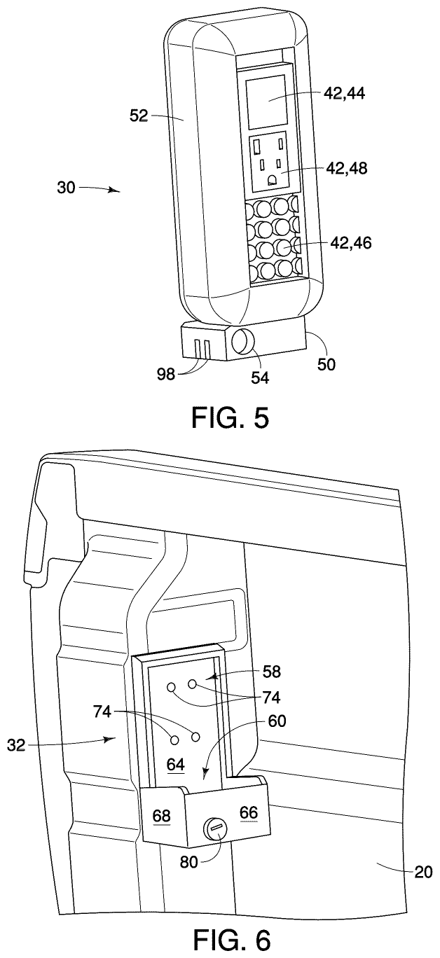

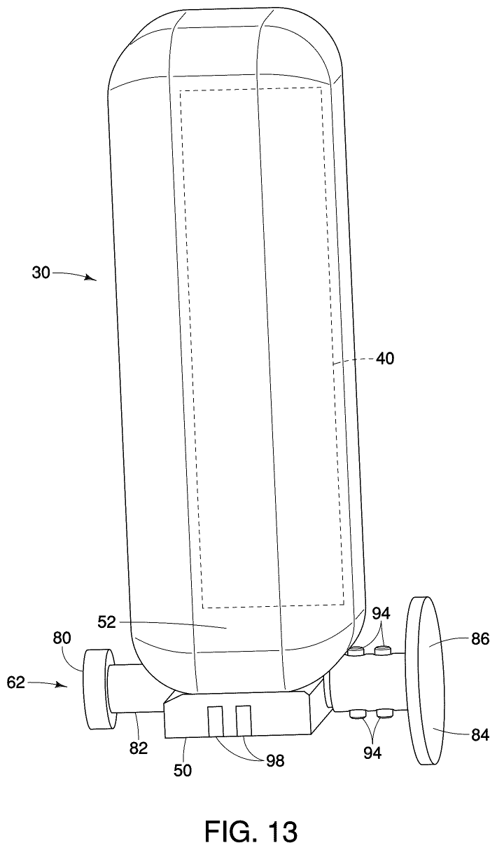

FIG. 5 illustrates an example embodiment of the portable electronic device 30. The portable electronic device 30 generally includes a rechargeable battery 40 (see FIG. 13) and one or more electronic component 42 configured to use and/or enabling use of the rechargeable battery 40. In the illustrated embodiment, the electronic components 42 include a light 44 configured to be powered by the rechargeable battery 40, a speaker 46 configured to be powered by the rechargeable battery 40, and one or more outlet 48 for connection of another electrical device to be powered by the vehicle battery 14 and/or the rechargeable battery 40. In an embodiment, the portable electronic device 30 also includes Bluetooth capabilities powered by the rechargeable battery 40.

As seen in FIG. 4, each of the light 44, the speaker 46, and the one or more outlet 48 are positioned and arranged to be exposed for use while the portable electronic device 30 is locked into the portable device holder 32. In an embodiment, one or more of the light 44, the speaker 46 and the outlet 48 uses power from the vehicle battery 14 when the portable electronic device 30 is located in the portable device holder 32, and uses power from the rechargeable battery 40 when the portable electronic device 30 is detached from the portable device holder 32.

The exposed positioning of the portable electronic device 30 within the portable device holder 32 as shown in FIG. 4 enables the light 44 to provide light within the cargo bed 18 when locked into the portable device holder 32. For example, as seen in FIG. 2, the portable electronic device 30 can be located on a tail light column 22 facing the vehicle cabin 16, which allows the light 44 to illuminate the length of the cargo bed 18 up to the rear side of the passenger cabin 16. The light 44 is also configured to provide light away from the cargo bed 18 using power from the rechargeable battery 40 when the portable electronic device 30 is detached from the portable device holder 32. In an embodiment, the light 44 can be controlled from a control panel inside the passenger cabin 16 or within the cargo bed 18. In another embodiment, the light 44 can be controlled by a button or switch on the portable electronic device 30. In yet another embodiment, a user device such as a smart phone can use Bluetooth or another wireless method to control the light 44.

The exposed positioning of the portable electronic device 30 within the portable device holder 32 as shown in FIG. 4 enables the speaker 46 to provide sound to the cargo bed 18 when locked into the portable device holder 32. The speaker 46 also provides sound away from the cargo bed 18 using power from the rechargeable battery 40 when the portable electronic device 30 is detached from the portable device holder 32. In an embodiment, the speaker 46 can be connected to the audio system of the vehicle 10 and can be controlled from a control panel inside the passenger cabin 16 or within the cargo bed 18. In another embodiment, the speaker 46 can be controlled by a button or switch on the portable electronic device 30. In yet another embodiment, a user device such as a smart phone can use Bluetooth or another wireless method to control the speaker 46, for example, to adjust the volume or output desired audio.

The exposed positioning of the one or more outlet 48 within the portable device holder 32 as shown in FIG. 4 enables the one or more outlet 48 to receive an electrical plug from another electrical device while the portable electronic device 30 is locked into the portable device holder 32. The one or more outlet 48 can include any type of outlet or port, for example, for standard electrical plugs, USB plugs, etc. In an embodiment, the one or more outlet 48 provides power from the vehicle battery 14 when the vehicle 10 is running and the portable electronic device 30 is locked into the portable device holder 32, and provides power from the rechargeable battery 40 when the portable electronic device 30 is detached from the portable device holder 32. In an embodiment, the portable device 30 can provide wireless charging capabilities from the rechargeable battery 40 instead of or in addition to having the one or more outlet 48.

As seen in FIG. 5, the portable electronic device 30 includes a locking portion 50 and a gripping portion 52. The locking portion 50 is configured to lock into the portable device holder 32, for example, so that the rechargeable battery 40 can be charged and/or the light 44, speaker 46 and/or outlet 48 can be used from the cargo bed 18. The gripping portion 52 is configured to be gripped and pulled by a user to remove the portable electronic device 30 from the portable device holder 32 so that the portable electronic device 30 can be used remotely from outside the vehicle 10. The gripping portion 52 also provides a waterproof housing for the removeable battery 40 and other electrical components.

The portable device holder 32 leaves the gripping portion 52 exposed so that the portable electronic device 30 can be removed from the portable device holder 32 when the portable electronic device 30 is unlocked from the portable device holder 32. From the perspective of FIG. 4, the portable electronic device 30 is gripped at the gripping portion 52 and pulled upward vertically for removal from the portable device holder 32. In an embodiment, the gripping portion 52 can include a gripping surface made of a material such as rubber that is easy to grip, and/or can include ridges or other shapes to assist with gripping the gripping portion 52. The housing of the gripping portion 52 can be formed of metal, plastic, or another suitable material.

As seen in FIG. 5, the locking portion 50 is located below the gripping portion 52 and includes a locking cavity 54. As discussed in more detail below, the locking cavity 54 receives a locking mechanism 62 that locks the portable electronic device 30 into the portable device holder 32 and unlocks the portable electronic device 30 from the portable device holder 32. In the illustrated embodiment, the locking cavity 54 is an aperture extending laterally through the locking portion 50. The locking portion 50 can be formed of metal, plastic, or another suitable material.

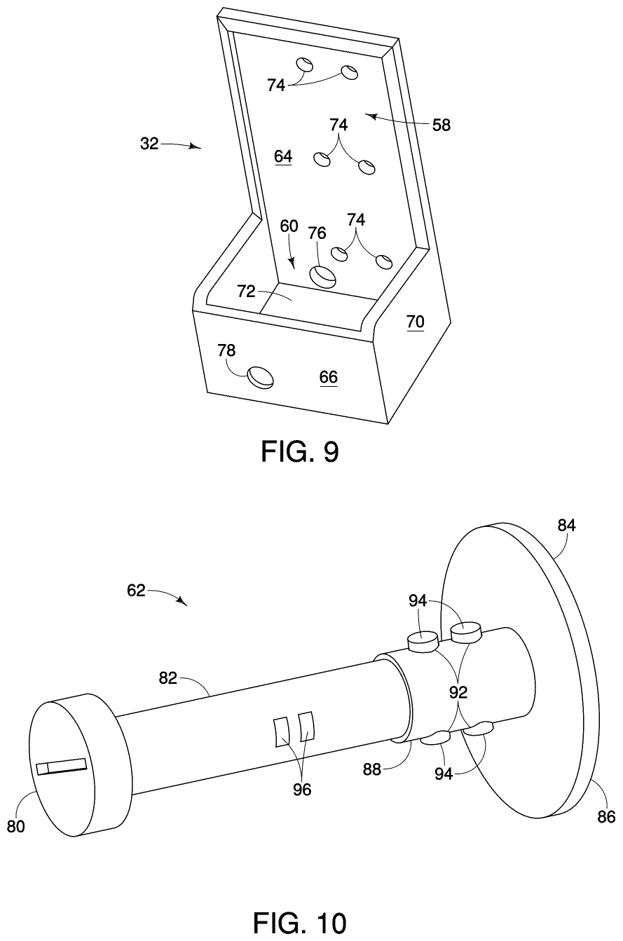

FIGS. 6 to 12 illustrate an example embodiment of the portable device holder 32, which is configured to retain the portable electronic device 30 while the rechargeable battery 40 is charged by the vehicle battery 14. The portable device holder 32 is also configured to be mounted and/or moved to various locations of the vehicle 10.

The portable device holder 32 generally includes a mount 58 and a device cavity 60. The mount 58 is configured to attach the portable device holder 32 to the vehicle 10, while the device cavity 60 is configured to receive the portable electronic device 30. More specifically, the device cavity 60 is configured to receive at least the locking portion 50 of the portable electronic device 30. In an embodiment, the device cavity 60 also receives at least part of the gripping portion 52.

In the illustrated embodiment, the mount 58 is formed by a rear wall 64 of the portable device holder 32, while the device cavity 60 is formed by the rear wall 64 and one or more of a front wall 66, a first side wall 68, a second side wall 70 and a bottom wall 72. That is, the rear wall 64 forms at least a portion of the device cavity 60 while also forming the mount 58 for attachment to the vehicle 10. The rear wall 64, the front wall 66, the first side wall 68, the second side wall 70 and/or the bottom wall 72 can be formed of metal, plastic, or another suitable material.

In the illustrated embodiment, the rear wall 64 includes a plurality of attachment apertures 74 for attaching the portable device holder 32 to the lateral side walls 20 of the vehicle 10. For example, the portable device holder 32 can be attached to the tail light column 22 of a lateral side wall 20 by bolts or screws through the apertures 74. The rear wall 64 also includes a first aperture 76 for receiving the locking mechanism 62, and the front wall 66 includes a second aperture 78 for receiving the locking mechanism 62, as described in more detail below.

In an embodiment, the bottom wall 72 includes one or more apertures that act as a drain for water or other liquid that enters the device cavity 60, for example, due to rain or snow. The bottom wall 72 can also be angled or include drain channels to direct water or other liquid to the drain apertures.

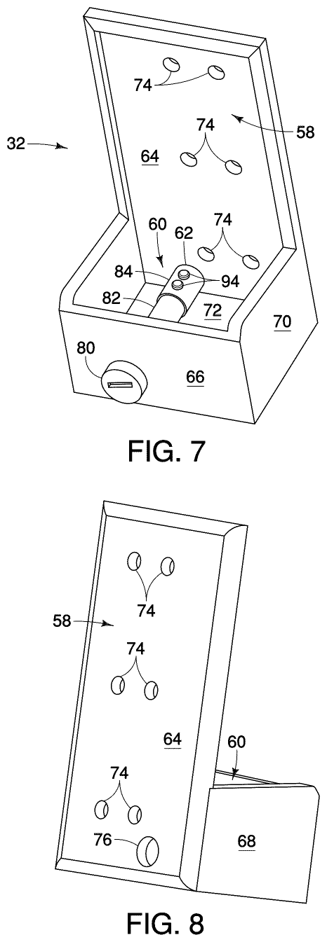

As seen in FIG. 7, the portable device holder 32 includes a locking mechanism 62 which cooperates with the locking cavity 54 and the device cavity 60 to lock the portable electronic device 30 into the portable device holder 32. The locking mechanism 62 is configured to be placed in a locked configuration and an unlocked configuration. The locked configuration locks the portable electronic device 30 into the device cavity 60 while the rechargeable battery 40 is charged by the vehicle 14. The unlocked configuration enables the portable electronic device 30 to be removed from the device cavity 60 and used remotely from outside the vehicle 10. The parts of the locking mechanism 62 can be formed of metal, plastic, or another suitable material.

The locking portion 50 of the portable electronic device 30 is located within the device cavity 60 when the portable electronic device 30 is locked by the locking mechanism 62. When in the unlocked configuration, the portable electronic device 30 can be removed from the device cavity 60 by a user gripping the gripping portion 52 and pulling the portable electronic device 30 from the device cavity 60. As seen in FIG. 4, the gripping portion 52 is located at least partly outside of the device cavity 60 when the portable electronic device 30 is locked into the portable device holder 32. The portable device holder 32 leaves the gripping portion 52 exposed so that the portable electronic device 30 can be removed from the portable device holder 32 by gripping and pulling the portable electronic device 30 at the gripping portion 52.

FIGS. 10 to 12 illustrate the locking mechanism 62 in more detail. In the illustrated embodiment, the locking mechanism 62 generally includes a keyed part 80, a locking rod 82 and a rod receiving part 84. In use, the keyed part 80 enables a user to lock and unlock the locking rod 82 from the rod receiving part 84 while the portable device holder 32 is attached to the vehicle 10. The locking rod 82 engages the rod receiving part 84 to lock the portable electronic device 30 into the portable device holder 32, and disengages the rod receiving part 84 to unlock the portable electronic device 30 from the portable device holder 32.

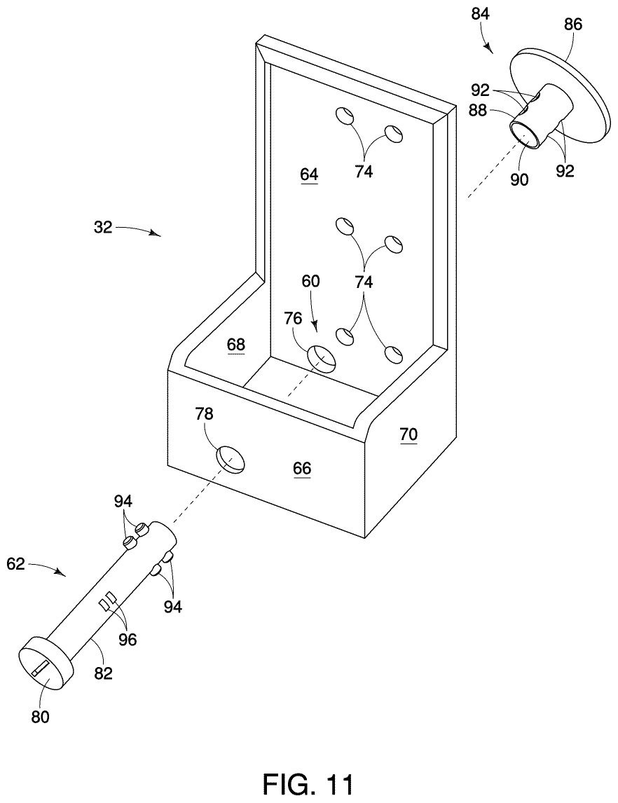

FIG. 11 illustrates how the locking mechanism 62 is attached to and located within the device cavity 60. The rod receiving part 84 extends through the first aperture 76 in the rear wall 64. The rod receiving part 84 is thus located within the device cavity 60 to receive the locking rod 82. The locking rod 82 extends through the second aperture 78 in the front wall 66 to lock into the rod receiving part 84. The locking rod 82 thus extends through the device cavity 60 and into the rod receiving part 84 when the locking mechanism 62 is in the locked configuration. In use, the locking rod 82 is configured to translate within the locking cavity 54 and the device cavity 60 to lock the portable electronic device 30 into the device cavity 60 while the rechargeable battery 40 is charged by the vehicle 10.

In the illustrated embodiment, the rod receiving part 84 generally includes rear end stop 86 and an axial protrusion 88. The rear end stop 86 has an outer diameter or shape which is larger than the first aperture 76 in the rear wall 64. The axial protrusion 88 protrudes through the first aperture 76 and into the device cavity 60 with the rear end stop 86 abutting the outside of the rear wall 64. When the portable device holder 32 is attached to a vehicle side wall 20 as shown in FIG. 4, the rear end stop 86 is tightly located between the vehicle side wall 20 and the rear wall 64 so that the rod receiving part 84 cannot be removed unless the portable device holder 32 is detached from the vehicle side wall 20. In an embodiment, the rod receiving part 84 can also be fixed to the rear wall 64 using screws, bolts, etc.

As shown in FIG. 11, the axial protrusion 88 includes an axial cavity 90 and one or more radial cavities 92. The axial cavity 90 extends into the axial protrusion 88 generally in an axial direction. The one or more radial cavities 92 extend generally in a radial direction. In the illustrated embodiment, the radial cavities 92 are apertures that extend through the side wall of the axial protrusion 88 into communication with the axial cavity 90, but the radial cavities 92 can also be cavities located entirely within the axial cavity 90 of the axial protrusion 88.

As also shown in FIG. 11, the locking rod 82 is an axially extending rod, extending from the keyed part 80 to an opposite end including one or more radially protruding pins 94. When the locking mechanism 62 is in the locked configuration, the locking rod 82 extends into the axial cavity 90, and the radial protruding pins 94 extend into the radial cavities 92. The radially protruding pins 94 lock the locking rod 82 into the axial cavity 90. The radially protruding pins 94 thus prevent removal of the locking rod 82 from the locking cavity 54 and the device cavity 60 when the locking mechanism 62 is in the locked configuration. The illustrated embodiment shows two radially protruding pins 94 on each of opposite sides of the locking rod 82, but alternative embodiments can include a single pin, pins on only one side, or other pin configurations.

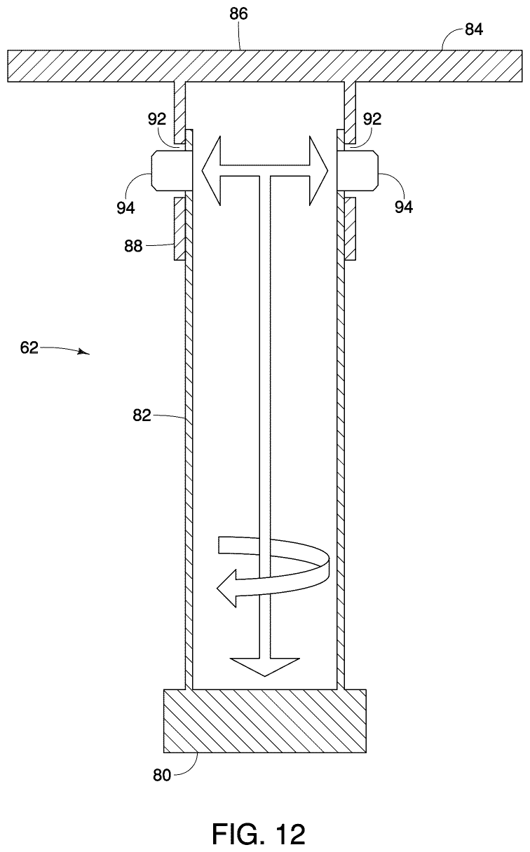

FIG. 12 illustrates how the locking rod 82 is locked into and unlocked from the rod receiving part 84. To lock the portable electronic device 32 into the portable device holder 30, the locking rod 82 translates within the device cavity 60 toward the rear wall 64. More specifically, the locking rod 82 translates in the axial direction through the locking cavity 54 of the portable electronic device 30 and into the axial cavity 90 of the rod receiving part 84. The locking rod 82 then rotates so that the radially protruding pins 94 protrude into the radial cavities 92 of the rod receiving part 84, which locks the portable electronic device 32 into the portable device holder 30. The portable electronic device 30 cannot be removed from the device cavity 30 while the locking rod 82 is located in the locking cavity 54. To unlock the portable electronic device 32 from the portable device holder 30, the locking rod 82 is rotated in the opposite direction to remove the radially protruding pins 94 from the radial cavities 92, and then the locking rod 82 is translated away from the rod receiving part 84 and out of the locking cavity 54 of the portable electronic device 30. The illustrated locking rod 82 thus rotates around the central axis thereof and translates axially along the central axis when moving between the locked configuration and the unlocked configuration.

In an embodiment, the radial protrusions 94 prevent the locking rod 82 from completely detaching from the rest of the portable device holder 32 at the second aperture 78 of the front wall 66, so that the locking rod 82 is not misplaced while the portable electronic device 30 is unlocked and used away from the vehicle 10. Alternatively, the locking rod 82 can include an additional radial protrusion or another element that prevents the locking rod 82 from detaching from the rest of the portable device holder 30.

In an embodiment, the keyed part 80 enables the user to lock and unlock the locking rod 82 into the rod receiving part 84. In an embodiment, the locking rod 82 will only rotate when the key to the keyed part 80 is used. In an embodiment, the radially protruding pins 94 remain fixed in the radial cavities 92 of the rod receiving part 84 unless the key to the keyed part 80 is used.

In an embodiment, the radially protruding pins 94 move in a radial direction of the locking rod 82 and are biased outward in the radial direction, such that the radially protruding pins 94 move outwardly into the radial cavities 92 once rotationally aligned. In an embodiment, the axial cavity 90 can include, for example, one or more inner surfaces (e.g., ramped or curved surfaces) that cause the radially protruding pins 94 to move against the biasing force and into the locking rod 82 as the locking rod 82 moves through the axial cavity 90, and that then allow the biasing force to push the radially protruding pins 94 outwardly into the radial cavities 92 once rotationally aligned.

In an embodiment, the rod receiving part 84 includes indentations or slots that allow the radially protruding pins 94 to move through the rod receiving part 84 in a first rotational position, and then rotate to a second rotational position into the radial cavities 92 to lock into the rod receiving part 84 (e.g., rotate 90 degrees).

As seen in FIG. 4, the portable device holder 32 includes an electrical contact 29 configured to electrically connect the rechargeable battery 40 to the vehicle battery 14 so that the vehicle battery 14 can recharge the rechargeable battery 40. Here, the electrical contact 29 is located on the inner surface of the side wall 68. As seen in FIG. 5, the portable electronic device 30 includes a corresponding electrical contact 98 at an outer surface of the locking portion 40. When the portable electrical device 30 is properly inserted into the portable device holder 32, the electrical contact 29 electrically connects with the electrical contact 98 so that the vehicle battery 14 can recharge the rechargeable battery 40 and/or provide power to the electronic components 42. In an embodiment, the electrical contact 98 can also be located on the gripping portion 52 of the portable electronic device 30.

FIG. 10 illustrates another example embodiment of the portable device holder 32 including an electrical contact 96 configured to electrically connect the rechargeable battery 40 to the vehicle battery 14 so that the vehicle battery 14 can charge the rechargeable battery 40. In the illustrated embodiment, the electrical contact 96 is located on the locking rod 82 of the locking mechanism 62. The electrical contact 96 is configured to electrically connect to a corresponding electrical contact within the locking aperture 54 of the locking portion 50 when the locking mechanism 62 is rotated into the locked configuration. In other embodiments, the electrical contact 96 can also be located on the keyed portion 80 or the rod receiving part 84.

When constructed as discussed herein, the portable electronic device 30 is configured to lock into the portable device holder 32 with the locking portion 50 located in the device cavity 60, have the rechargeable battery 40 recharged by the vehicle battery 14 while locked into the portable device holder 32, and then unlock from the portable device holder 32 to be used remotely from outside the cargo bed 18 using power from the rechargeable battery 40.

Any number of portable electronic device assemblies 12 can be used on a vehicle 10. When multiple portable electronic device assemblies 12 are used, the portable electronic devices 30 and portable device holders 32 can be used interchangeably. For example, as shown in FIG. 2, the illustrated vehicle 10 includes a first portable electronic device assembly 12a and a second portable electronic device assembly 12b. The first portable electronic device assembly 12a includes a first portable electronic device 30 and a first portable device holder 32. The second portable electronic device assembly 12b includes a second portable electronic device 30 and a second portable device holder 32. The first portable device holder 32 is attached to the first lateral sidewall 20a of the cargo bed 18. The second portable device holder 32 is attached to the second lateral sidewall 20b of the cargo bed 18, which is located opposite the first sidewall 20a. In this embodiment, the first portable electronic device 30 and the second portable electronic device 30 are each configured to be locked into either of the first portable device holder 32 and the second portable device holder 32. That is, the first portable electronic device 30 can be used interchangeably with the second electronic device 30, and can be recharged by either portable device holder 32.

The embodiments described herein provide improved systems and methods for equipping a vehicle with a portable electronic device assembly. These systems and methods are advantageous, for example, because they enable dual use of a portable electronic device as both a cargo bed accessory and a removeable electronic device. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A portable electronic device assembly for a vehicle, the portable electronic device assembly comprising:
a portable electronic device including a rechargeable battery; and
a portable device holder configured to retain the portable electronic device while the rechargeable battery is charged by the vehicle, the portable device holder including
a device cavity configured to receive the portable electronic device, and
a locking rod configured to extend into the device cavity and be rotated when moving between (i) a locked configuration that locks the portable electronic device into the device cavity while the rechargeable battery is charged by the vehicle, and (ii) an unlocked configuration that enables the portable electronic device to be removed from the device cavity and used remotely from outside the vehicle.

2. The assembly of claim 1, wherein
the portable electronic device includes a locking cavity, and
the locking rod extends into the locking cavity at least when in the locked configuration.

3. The assembly of claim 1, wherein
the locking rod rotates around a central axis thereof and translates axially along the central axis when moving between the locked configuration and the unlocked configuration.

4. The assembly of claim 1, wherein
the locking rod includes one or more axially protruding pins which prevent removal of the locking rod from the device cavity when the locking rod is in the locked configuration.

5. The assembly of claim 1, wherein
the portable device holder includes a rod receiving part located within the device cavity, and
the locking rod extends through the device cavity and into the rod receiving part when the locking rod is in the locked configuration.

6. The assembly of claim 1, wherein
the portable device holder includes an electrical contact configured to electrically connect the rechargeable battery to a vehicle battery when the portable electronic device is located within the device cavity so that the vehicle battery recharges the rechargeable battery.

7. The assembly of claim 1, wherein
the portable electronic device includes at least one of: (i) a light configured to be powered by the rechargeable battery, (ii) a speaker configured to be powered by the rechargeable battery, and (iii) an outlet for connection of an electrical device.

8. A portable electronic device assembly for a vehicle, the portable electronic device assembly comprising:
a portable electronic device including a rechargeable battery; and
a portable device holder configured to retain the portable electronic device while the rechargeable battery is charged by the vehicle, the portable device holder including
a mount configured to attach to a vehicle wall;
a device cavity configured to receive the portable electronic device, and
a locking mechanism configured to be placed in a locked configuration that locks the portable electronic device into the device cavity and an unlocked configuration that enables the portable electronic device to be removed from the device cavity and used remotely from outside the vehicle.

9. The assembly of claim 8, wherein
the mount includes a rear wall that also forms at least a portion of the device cavity.

10. The assembly of claim 8, wherein
the locking mechanism includes a locking rod configured to translate within the device cavity to lock the portable electronic device into the device cavity while the rechargeable battery is charged by the vehicle.

11. The assembly of claim 10, wherein
the locking mechanism includes a rod receiving part, and
the locking rod extends through the device cavity and into the rod receiving part when the locking mechanism is in the locked configuration.

12. The assembly of claim 8, wherein
the portable electronic device includes a locking portion and a gripping portion,
the locking portion is located within the device cavity when the portable electronic device is locked by the locking mechanism, and
the portable device holder leaves the gripping portion exposed so that the portable electronic device can be removed from the portable device holder when the locking mechanism is in the unlocked configuration by gripping and pulling the portable electronic device at the gripping portion.

13. The assembly of claim 8, wherein
the portable device holder includes an electrical contact configured to electrically connect the rechargeable battery to a vehicle battery when the portable electronic device is located within the device cavity so that the vehicle battery recharges the rechargeable battery.

14. The assembly of claim 8, wherein
the portable electronic device includes at least one of: (i) a light configured to be powered by the rechargeable battery, (ii) a speaker configured to be powered by the rechargeable battery, and (iii) an outlet for connection of an electrical device.

15. A vehicle comprising:
a vehicle battery;
a passenger cabin including electrical components using power from the vehicle battery;
a cargo bed located on a rear side of the passenger cabin and including a lateral side wall;
a portable device holder attached to the lateral side wall, the portable device holder including a device cavity; and
a portable electronic device including a locking portion and a rechargeable battery, the portable electronic device configured to (i) lock into the portable device holder with the locking portion located in the device cavity, (ii) have the rechargeable battery recharged by the vehicle battery when locked into the portable device holder, and (iii) unlock from the portable device holder to be used remotely from outside the cargo bed using power from the rechargeable battery.

16. The vehicle of claim 15, wherein
the portable device holder is a first portable device holder,
the portable electronic device is a first portable electronic device,
the vehicle further includes a second portable device holder and a second portable electronic device,
the first portable device holder is attached to a first lateral sidewall of the cargo bed,
the second portable device holder is attached to a second lateral sidewall of the cargo bed located opposite the first sidewall, and
the first portable electronic device and the second portable electronic device are each configured to be locked into either of the first portable device holder and the second portable device holder.

17. The vehicle of claim 15, wherein
the portable electronic device includes a gripping portion located outside of the device cavity when the portable electronic device is locked into the portable device holder, and
the portable electronic device is removed from the device cavity by a user gripping the gripping portion and pulling the portable electronic device from the device cavity.

18. The vehicle of claim 15, wherein
the portable device holder includes a locking rod configured to extend into the device cavity and be rotated to be placed in a locked configuration that locks the portable electronic device into the device cavity.

19. The vehicle of claim 18, wherein
the locking rod includes one or more axially protruding pins which prevent removal of the locking rod from the device cavity when the locking rod is in the locked configuration.

20. The vehicle of claim 15, wherein
the portable electronic device includes at least one of: (i) a light configured to be powered by the rechargeable battery, (ii) a speaker configured to be powered by the rechargeable battery, and (iii) an outlet for connection of an electrical device.
